(19) United States
(12) Patent Application Publication
(10) Pub. No.: US 2010/0290154 A1
(43) Pub. Date: Nov. 18, 2010

(54) HARD DISK DRIVE

(75) Inventors: Yu-Sung KIM, Seoul (KR); Yong-Jae Kim, Seoul (KR); Ki Tag Jeong, Hwasung-si (KR); Hyung-Jun Lee, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/772,368

(22) Filed: May 3, 2010

(30) Foreign Application Priority Data
May 14, 2009 (KR) 2009-0042266

(51) Int. Cl. G11B 33/14; F16M 13/00

(52) U.S. Cl. 360/97.02; 248/310; 248/636; G9B/33.035

(57) ABSTRACT

A hard disk drive includes a base, a screw housing includes at least one screw hole wall formed with a screw hole, and provided at lateral sides of the base, and a shock-absorbing space formed between the base and at least a part among outer walls of the screw housing. The base is a structure to absorb at least a part of a shock due to external impact and/or vibration applied to an external structure to which the hard disk drive is mounted, such that a defect due to external shock and/or vibration can be decreased.

### CROSS-REFERENCE TO RELATED APPLICATIONS

This application claims priority under 35 U.S.C. §119(a) from Korean Patent Application no. 10-2009-0042266, filed on May 14, 2009, in the korean intellectual property office, the disclosure of which is incorporated herein by reference in its entirety.

### BACKGROUND

1. Field of the Invention

The present general inventive concept relates to an auxiliary memory unit of a computer system, and more particularly, to a hard disk drive of which a base has a structure to absorb a shock such as external impact or vibration applied to an external structure to which the hard disk drive is mounted.

2. Description of the Related Art

A hard disk drive (HDD), which uses a reading/writing head to record data on a disk or load the data from the disk, has been widely used as an auxiliary memory unit of a computer system or the like since it can access a lot of data at high speed.

Such a hard disk drive includes a base forming a basic frame, a disk pack having a disk, a head stack assembly (HSA) having a reading/writing head, a printed circuit board assembly (PCBA) where a plurality of chips are mounted, a voice coil motor (VCM), and a cover for shielding a top of the base.

Further, screw housings formed with a plurality of screw holes to which screws are fastened are provided at opposite side walls of the base. The screw holes of the screw housings are used when the hard disk drive is coupled to a bracket of a notebook personal computer (PC) or when the hard disk drive is coupled to a jig of test equipment for impact and vibration tests. In general, the screw housings formed with the screw holes are formed integrally with the base.

However, in a conventional hard disk drive, when impact, vibration or the like is applied to an external structure where the hard disk drive is mounted, a shock due to this impact, vibration or the like is directly transferred to the base through the screw housing and then transferred again to elements mounted to the base, such as the HSA, the VCM, etc. If this shock is not properly absorbed but excessive, the above elements may be changed in properties and become defective.

Taking this problem into account, there has been proposed method of using elements that more resistant to the shock. However, this method has disadvantages in that additional costs are needed and it is not easy to analyze a cause of a defect if the defect arises.

### SUMMARY

The present general inventive concept provides a hard disk drive of which a base has a structure to absorb a shock such as external impact or vibration applied to an external structure to which the hard disk drive is mounted, so that a defect due to an external shock, which may arise in elements installed in the base, can be more decreased than that in a conventional one.

Additional features and utilities of the present general inventive concept will be set forth in part in the description which follows and, in part, will be obvious from the description, or may be learned by practice of the general inventive concept.

Exemplary embodiments of the present general inventive concept provide a hard disk drive including a base, a screw housing having at least one screw hole wall formed with a screw hole, and provided at lateral sides of the base, and a shock-absorbing space formed between the base and at least a part among outer walls of the screw housing except the screw hole wall.

The screw hole wall may be formed in two outer walls of the screw housing at positions exposed to an outside of the base, and the shock-absorbing space may be formed between the base and three outer walls among four outer walls of the screw housing.

The shock-absorbing space includes at least a first space and a second space formed between the base and three outer walls among four outer walls of the screw housing that may be coupled to the base in the form of a cantilever so that the first space and the second space of the shock-absorbing space continuously communicate with one another.

The screw housing may include a cantilever structure where a rear wall of the screw housing opposite to a lengthwise central axis of the base is coupled to the base.

The shock-absorbing space may be formed between the base and two outer walls among four outer walls of the screw housing.

The screw housing may include a double cantilever structure where two lateral walls of the screw housing are disposed transversely to a lengthwise central axis of the base and are coupled to the base.

A coupling wall to couple the two lateral walls of the screw housing with the base may include a cross-section inclined with respect to a top surface of the base.

The base and the screw housing may be a single body, and the shock-absorbing space may be provided by a slot formed in at least one of the base and the screw housing.

The shock-absorbing space may be provided by a slot formed in the base, and the shock-absorbing space may be filled with a damper material to absorb at least a part of a shock.

The base and the screw housing may be coupled with each other to form the shock-absorbing space.

The base and the screw housing may be formed of different materials from each other.

Exemplary embodiments of the present general inventive concept also provide a digital storage device mounting apparatus including a base to mount a digital storage device, and a screw housing having a plurality of sides and at least one screw hole wall, the screw housing mounted on a side of the base such that the plurality of sides of the screw housing are spaced from the side of the base.

The screw housing can include a double cantilever structure having two lateral walls that are disposed transversely to a lengthwise central axis of the base and are coupled to the base.

The apparatus can include a coupling wall to couple the two lateral walls of the screw housing with the base and that includes an inclined cross-section.

The apparatus can include a damping material disposed between the base and the plurality of sides of the screw housing.

The apparatus can include where the base and the screw housing are formed of different materials from one another.

Exemplary embodiments of the present general inventive concept also provide a hard disk drive assembly, including a base to support a digital storage device, and a screw housing extending from the based an separated from side walls of the base to provide a shock-absorbing space with respect to the walls of the base, the screw housing including a screw hole extending therethrough.

The hard disk drive assembly can include where the shock absorbing space is formed between the walls of the base and outer walls of the screw housing.

The hard disk assembly can include where the screw housing has a cantilever structure where a rear wall of the screw housing opposite to a lengthwise central axis of the base is coupled to the base.

The hard disk assembly can include where the shock absorbing space includes at least a first space and a second space formed between the base and the screw housing that is coupled to the base in the form of a cantilever so that the first space and the second space of the shock absorbing space continuously communicate with one another.

### BRIEF DESCRIPTION OF THE DRAWINGS

Exemplary embodiments of the present general inventive concept will be more clearly understood from the following detailed description taken in conjunction with the accompanying drawings in which:

FIG. 1 is a partial exploded perspective view illustrating a hard disk drive according to exemplary embodiments of the present general inventive concept;

FIG. 2 is a perspective view illustrating a base of FIG. 1 at a different angle;

FIG. 3 illustrates an enlarged perspective view of a part in FIG. 2;

FIG. 4 illustrates a view of the part of FIG. 2 at a different angle;

FIG. 5 is a view schematically illustrating a part of a hard disk drive according to exemplary embodiments of the present general inventive concept;

FIG. 6 is a view schematically illustrating a part of a hard disk drive according to exemplary embodiments of the present general inventive concept;

FIG. 7 is a view schematically illustrating a part of a hard disk drive according to exemplary embodiments of the present general inventive concept; and

FIG. 8 is a view schematically illustrating a part of a hard disk drive according to exemplary embodiments of the present general inventive concept.

### DETAILED DESCRIPTION OF THE EMBODIMENTS

The attached drawings illustrating exemplary embodiments of the present general inventive concept are referred to in order to gain a sufficient understanding of the present general inventive concept and the merits thereof.

Hereinafter, the present general inventive concept will be described in detail by explaining exemplary embodiments of the present general inventive concept with reference to the attached drawings. Like reference numerals in the drawings denote like elements. The embodiments are described below in order to explain the present general inventive concept by referring to the figures.

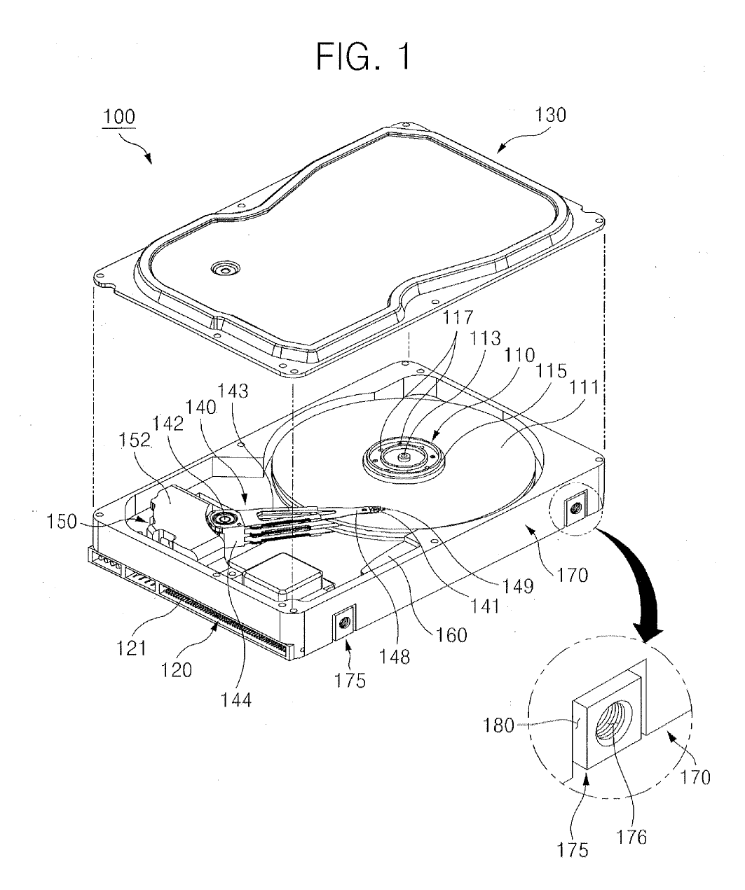

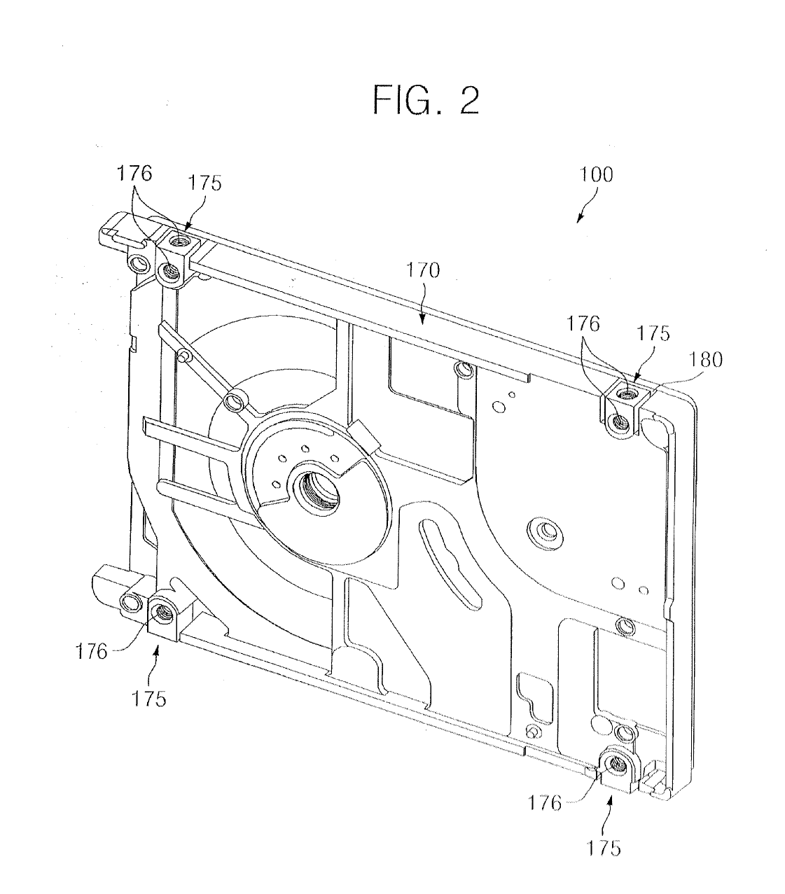

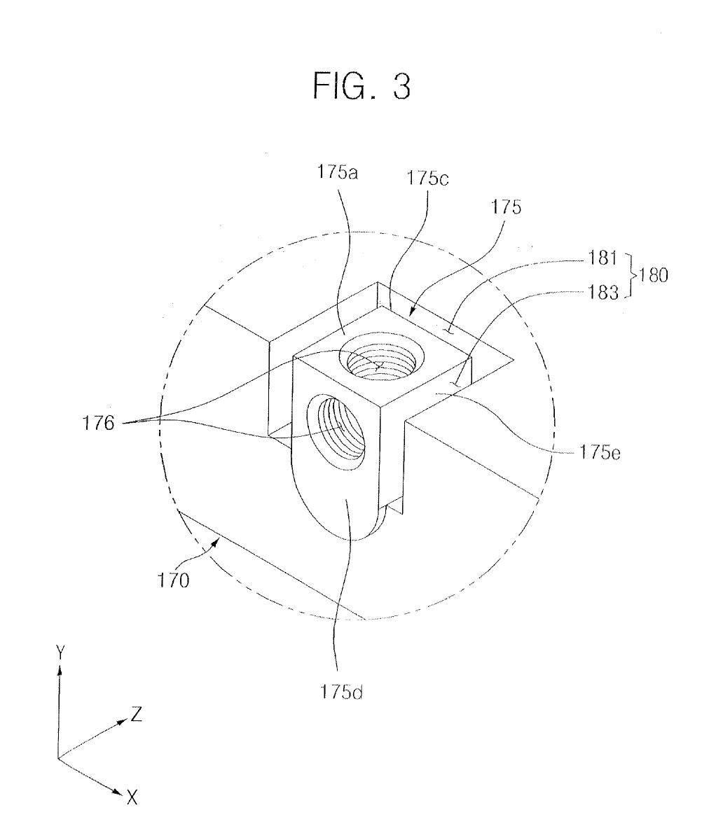

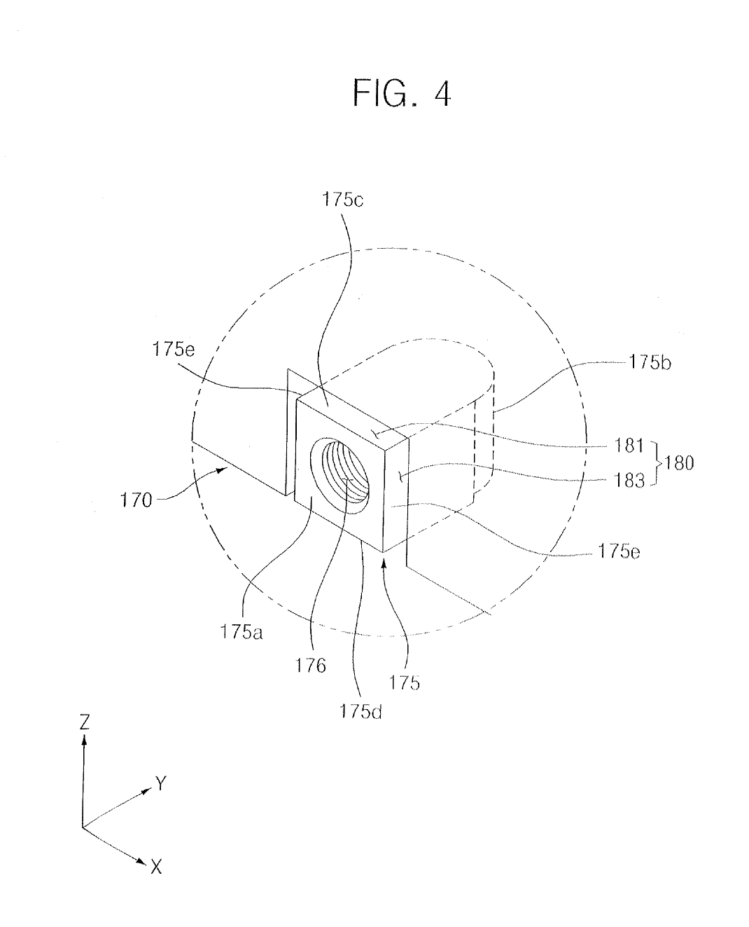

FIG. 1 illustrates a partial exploded perspective view of a hard disk drive according to exemplary embodiments of the present general inventive concept, FIG. 2 illustrates a perspective view of a base of FIG. 1 at a different angle, FIG. 3 illustrates an enlarged perspective view of a part in FIG. 2, and FIG. 4 illustrates a view of the part of FIG. 2 at a different angle.

As illustrated therein, a hard disk drive 100 according to exemplary embodiments of the present general inventive concept can include a disk pack 110 having a disk 111; a printed circuit board assembly (PCBA) 120; a head stack assembly (HSA) 140 that moves a reading/writing head 141 for reading and writing data on the disk 111 to a predetermined position on the disk 111; a voice coil motor (VCM) 150 that rotates an actuator arm 143 of the HSA 140; a ramp 160 where the reading/writing head 141 is parked when powered off or in the like case; a latch (not illustrated) that latches a bobbin 152 of the HSA 140 when the reading/writing head 141 is parked; a base 170 that forms a basic frame; and a cover 130 that shields a top of the base 170.

The hard disk drive 100 according to the exemplary embodiments of the present general inventive concept can include screw housings 175 that are respectively provided at opposite lateral side regions of the base 170 and can have screw hole walls 175a and 175d (refer to FIG. 3) formed with screw holes 176; and a shock-absorbing space 180 that can be formed between the base 170 and three lateral walls among outer walls of the screw housing 175 and can absorb a shock transferred by impact or vibration applied to an external structure. The shock-absorbing space 180 can be provided by forming a slot between the base 170 and the three lateral walls among the outer walls of the screw housing 175 the screw hole 176 can be formed in the screw housing 175 in order to screw-couple an external structure with the base 170. In exemplary embodiments of the present general inventive concept, the formed shock absorbing space 180 between the base 170 and three lateral walls among outer walls of the screw housing 175 may exclude the screw hole walls 175a and 175d.

The disk pack 110 includes the disk 111, a shaft 113 forming a rotational axis of the disk 111, a spindle motor hub (not illustrated) provided at a radial outside of the shaft 113 and supporting the disk 111, a clamp 115 coupled to an upper part of the spindle motor hub, and a clamp screw 117 pressing the clamp 115 so that the disk 111 can be fastened to the spindle motor hub.

The PCBA 120 can include a printed circuit board (PCB, not illustrated) shaped like a plate, and a PCB connector 121 can be provided at one side of the PCB. The PCB can include a plurality of chips (not illustrated) and circuits to control rotation of the disk 111 and operation of the reading/writing head 141, and can transmit and receive a signal to and from an exterior through the PCB connector 121.

The cover 130 can shield the top of the base 170 and can protect the disk pack 110, the HSA 140, etc.

The HSA 140 can be a carrier to record data on the disk 111 or to load the recorded data, which can include the reading/writing head 141 to write data on the disk 111 and to read the written data; an actuator arm 143 to rotate on the disk 111 with respect to a pivot shaft 142 so that the reading/writing head 141 can access the data on the disk 111; a suspension (not illustrated) coupled to an end part of the actuator arm 143; a pivot shaft holder 144 to rotatably support the pivot shaft 142 and to which the actuator arm 143 can be coupled and supported; and a bobbin 152 that can be provided in the pivot shaft holder 144 at an opposite side to the actuator arm 143 and placed between a pair of magnets (not illustrated) of the VCM 150.

The reading/writing head 141 can sense a magnetic field formed on a surface of the disk 111 and can magnetize the surface of the disk 111 to read information from the disk 111 or to write information on the disk 111. The reading/writing head 141 can include a reading head to sense the magnetic field of the disk 111 and a writing head to magnetize the disk 111.

As illustrated in FIG. 1, one end part of the actuator 143 can be provided with the suspension 148 that supports a slider (not illustrated) mounted with the reading/writing head 141 to be elastically biased toward the surface of the disk 111. An end tap 149 can be placed at and extended from an end part of the suspension 148. The end tap 149 can be parked on the ramp 160 when the hard disk drive 100 powered off or in the like case (e.g., when power is removed from the hard disk drive 100 and/or when a predetermined condition occurs).

The VCM 150 can be a driving motor that rotates the actuator arm 143 of the HSA 140 to move the reading/writing head 141 to a desired position on the disk 111, which employs fleming's left-hand rule, i.e., a principle that an electromagnetic force is generated when an electric current is applied to a conductive body existing in a magnetic field. By applying an electric current to a voice coil (not illustrated) placed between the magnets, the bobbin 152 can be forced to rotate, so that the actuator arm 143 can rotate in a predetermined direction. Thus, the reading/writing head 141 can be mounted to the end part of the actuator arm 143 can search and access a track while moving in a radial direction of the disk 111 being rotated, to write data on the disk 111 or to read the recorded data from the disk 111.

The latch (not illustrated) can latch the bobbin 152 connected to a back end part of the actuator arm 143 when powered off to minimize and/or prevent the actuator arm 143 from rotating.

The ramp 160 can be placed in the base 170 as a part where the reading/writing head 141 of the actuator arm 143 can be parked, and, more particularly, where the end tap 149 can be parked when the hard disk drive 100 is powered off.

The base 170 can be at least a part of a basic frame of the hard disk drive 100. The disk pack 110, the PCBA 120, the HSA 140, the VCM 150, the ramp 160, etc. can be mounted to the base 170.

The screw housings 175 can be coupled to the opposite side walls of the base 170 and can include the screw hole walls 175a and 175d (refer to FIG. 3) to be formed with the screw holes 176. To mount the hard disk drive 100 to an external structure, the screw housing 175 can be coupled to the external structure by a screw (not illustrated). When impact and/or vibration is applied to the external structure, a shock can be transferred to the base 170 through the screw housing 175 so that the impact and/or the vibration can be transferred to the elements mounted to the base 170 such as the HSA 140, the VCM 150, etc. mounted to the base 170. As described above, if this shock and/or vibration equals and/or exceeds a predetermined threshold amount, the above elements may be changed (e.g., their properties may change), may have decreased operation, and may become defective.

A shock-absorbing space 180 can be provided between the screw housing 175 and the base 170, so that a shock from an impact and/or vibration applied to the external structure can be minimized and/or absorbed by at least the screw housing 175.

The screw hole walls 175a and 175d can correspond to a front wall 175a and a bottom wall 175d. The shock-absorbing space 180 can be provided among the base 170 and the three lateral walls among the outer walls of the screw housing 175. The screw housing 175 can have a cantilever structure where one lateral wall of the screw housing 175 is coupled to the base 170. In exemplary embodiments of the present general inventive concept, the formed shock absorbing space 180 between the base 170 and three lateral walls among outer walls of the screw housing 175 may exclude the screw hole walls 175a and 175d.

The base 170 and the screw housing 175 can be formed as a single body, and the shock-absorbing space 180 can be provided by forming a slot in the base 170 between the base 170 and the three lateral walls among the outer walls of the screw housing 175. In exemplary embodiments of the present general inventive concept, the formed shock absorbing space 180 between the base 170 and three lateral walls among outer walls of the screw housing 175 may exclude the screw hole walls 175a and 175d. The screw housing 175 can have a structure that a rear wall 175b (refer to FIG. 4) of the screw housing 175 coupled to the base 170 can be a fixed end and a top wall 175c and lateral walls 175e (e.g., excluding the rear wall 175b) can be a free end. A cantilever structure of the screw housing 175 provided in the shock-absorbing space 180 can reduce and/or minimize the shock from an impact and/or vibration applied to the external structure by absorbing the shock with at least the base 170.

As illustrated in FIGS. 3 and 4, the shock-absorbing space 180 can include a first space 181 to attenuate an external force in up and down directions, and a second space 183 disposed transversely to the first space 181 and communicating with the first space 181. Here, the up and down directions refer to a thickness direction (e.g., a Z-axis direction) of the base 170, and left and right directions refer to a lengthwise direction (e.g., an X-axis direction) of the base 170.

The first space 181 can be provided between the top wall 175c of the screw housing 175 and the base 170 such that the screw housing 175 can be transformed in the up and down directions (e.g., the Z-axis directions) so as to minimize and/or absorb a shock and/or vibration when the screw housing 175 is coupled to an external structure by a screw and receives the shock and/or vibration in the up and down directions (e.g., the Z-axis direction).

The second space 183 can be provided between the base 170 and the lateral walls 175e of the screw housing 175 such that the screw housing 175 can be transformed in the left and right directions so as to minimize and/or absorb a shock and/or vibration when the screw housing 175 is coupled to an external structure by a screw and receives the shock and/or vibration in the left and right directions (e.g., the X-axis directions).

The screw housing 175 having the cantilever structure according to the first space 181 and the second space 183 can minimize and/or absorb external shocks and/or vibration in one or more directions. In exemplary embodiments of the present general inventive concept, external shocks can be absorbed and/or vibration can be minimized except the direction in which the screw housing 175 is coupled to the external structure by a screw.

When the hard disk drive 100 undergoes an impact and/or vibration test, defects may be minimized in comparison to a conventional hard disk drive. When a tip behavior test is applied to the actuator arm 143, a peak may be decreased and/or lower than that of a conventional hard disk drive.

In exemplary embodiments of the present general inventive concept, the screw housing 175 and the base 170 can be integrally made of the same metallic material, e.g., aluminum, in which the shock-absorbing space 180 can be provided by forming a slot in the base 170, but not limited thereto. Alternatively, the base 170 and the screw housing 175 may be separately made of the same material, and the screw housing 175 may be coupled to the base 170 so that the shock-absorbing space 180 can be formed. The base 170 and the screw housing 175 may be separately made of different materials from each other and then the screw housing 175 may be coupled to the base 170 so that the shock-absorbing space 180 can be formed.

Although it is not illustrated, the shock-absorbing space 180 in the exemplary embodiments of the present general inventive concept may be filled with a damper material (not illustrated) to increase a shock-absorbing and/or vibration damping effect. Here, the damper material may be provided corresponding to the shape of the spaces 181 and 183 of the shock-absorbing space 180, and may be made of rubber having shock absorbing properties and/or any other suitable material to carry out the exemplary embodiments of the present general inventive concept as disclosed herein. The shock and/or vibration transferred to the base can be absorbed by the damper material and the cantilever structure of the screw housing 175.

In the exemplary embodiments of the present general inventive concept illustrated in FIGS. 3 and 4, a shock and/or vibration from an external impact and/or vibration applied to an external structure, to which the hard disk drive is mounted, can be absorbed and/or minimized in the base. Elements installed in the base can have increased protection from damage from external shock and/or vibration than those of a conventional case.

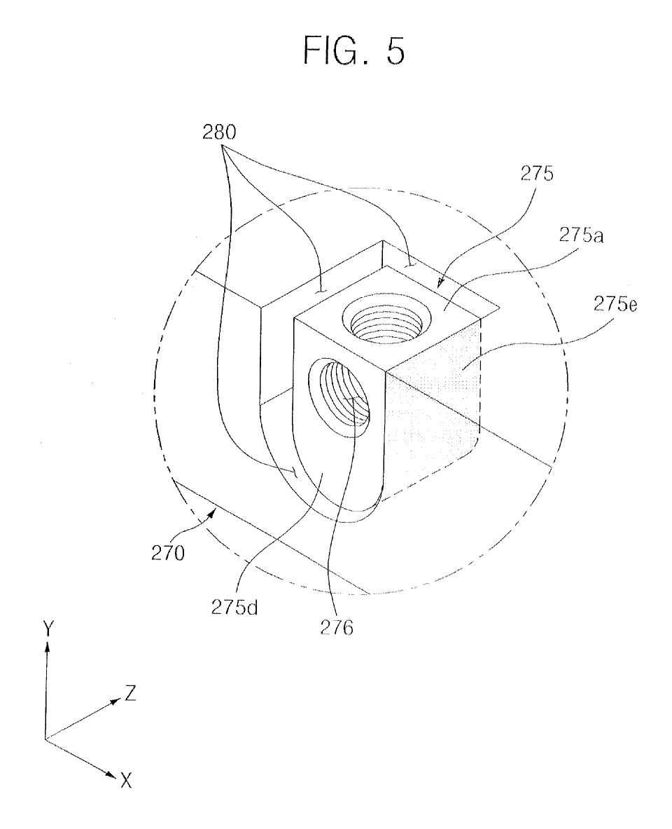

A hard disk drive according to exemplary embodiments of the present general inventive concept will be described with reference to the accompanying illustration in FIG. 5. Here, repetitive descriptions to the hard disk drive according to the exemplary embodiments of the present general inventive concept described above in connection with FIGS. 1-4 will be avoided.

FIG. 5 is a view schematically illustrating a part of a hard disk drive (e.g., hard disk drive 100) according to exemplary embodiments of the present inventive concept. The base 270 of the hard disk drive can include a screw housing 275 and at least one screw hole 276 to receive a screw to mount the hard disk drive to an external structure. As illustrated in FIG. 5, a shock-absorbing space 280 of the hard disk drive according to the exemplary embodiments of the present general inventive concept can be the same as that of the exemplary embodiments described above in that it is provided by forming a slot in a base 270 between the base 270 and three lateral walls among outer walls of a screw housing 275 (e.g., except screw hole walls 275a and 275d). In the exemplary embodiments of the present general inventive concept illustrated in FIG. 5, one lateral wall 275e that is among both lateral walls of the screw housing 275 can be integrally coupled to the base 270.

In the hard disk drive in the exemplary embodiments of the present general inventive concept as illustrated in FIG. 5, the screw housing 275 can have a cantilever structure that can be transformed by external impact and/or vibration in up and down directions (e.g., the Z-axis direction) of the base 270 and in a direction (e.g., the Y-axis direction) transverse to a lengthwise direction of the base 270, thereby minimizing and/or absorbing the shock and/or vibration applied in one or more directions.

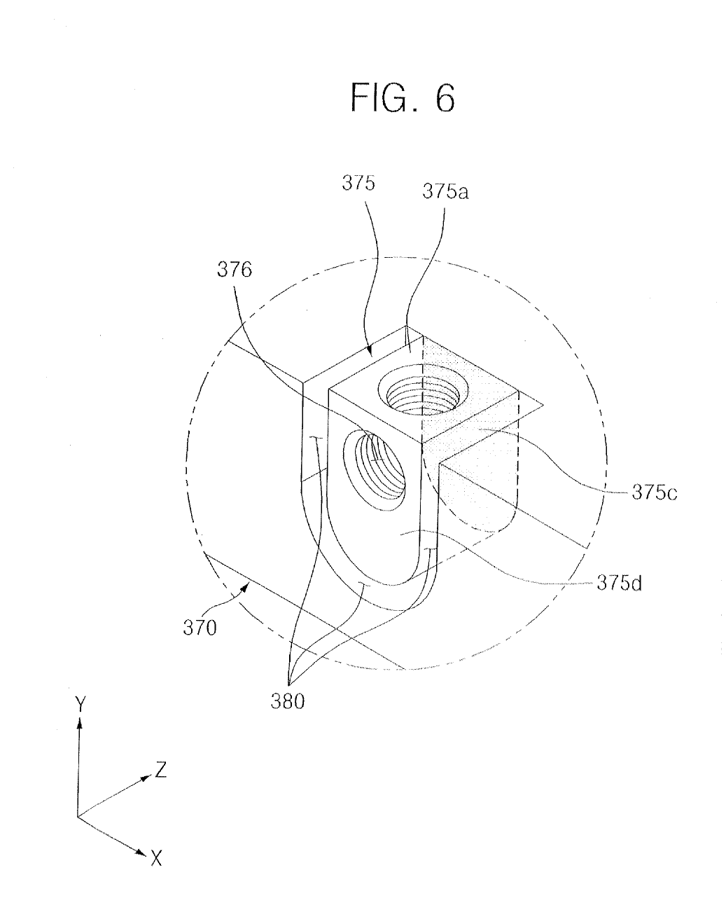

Below, a hard disk drive according to exemplary embodiments of the present general inventive concept will be described with reference to FIG. 6. Here, repetitive descriptions to the hard disk drive according to the exemplary embodiments of the present general inventive concept illustrated in FIGS. 1-5 and described above will be avoided.

FIG. 6 is a view schematically illustrating a part of a hard disk drive according to exemplary embodiments of the present inventive concept. A base 370 of the hard disk drive can include a screw housing 375 and at least on screw hole 376 to receive a screw to mount the hard disk drive to an external structure. As illustrated therein, a shock-absorbing space 380 of the hard disk drive according to exemplary embodiments of the present general inventive concept is the same as that of the above-described exemplary embodiments in that it is provided by forming a slot in a base 370 between the base 370 and three lateral walls among outer walls of a screw housing 375 except screw hole walls 375a and 375d. The exemplary embodiments illustrated in FIG. 6 can include a top wall 375c of the screw housing 375 that can be integrally coupled to the base 370.

In the hard disk drive according to the exemplary embodiments illustrated in FIG. 6, the screw housing 375 can have a cantilever structure that can be transformed by external impact and/or vibration in a lengthwise direction (e.g., an X-axis direction) of the base 370 and in a direction (e.g., a Y-axis direction) transverse to a lengthwise direction of the base 370, to absorb the shock and/or vibration applied in one or more directions.

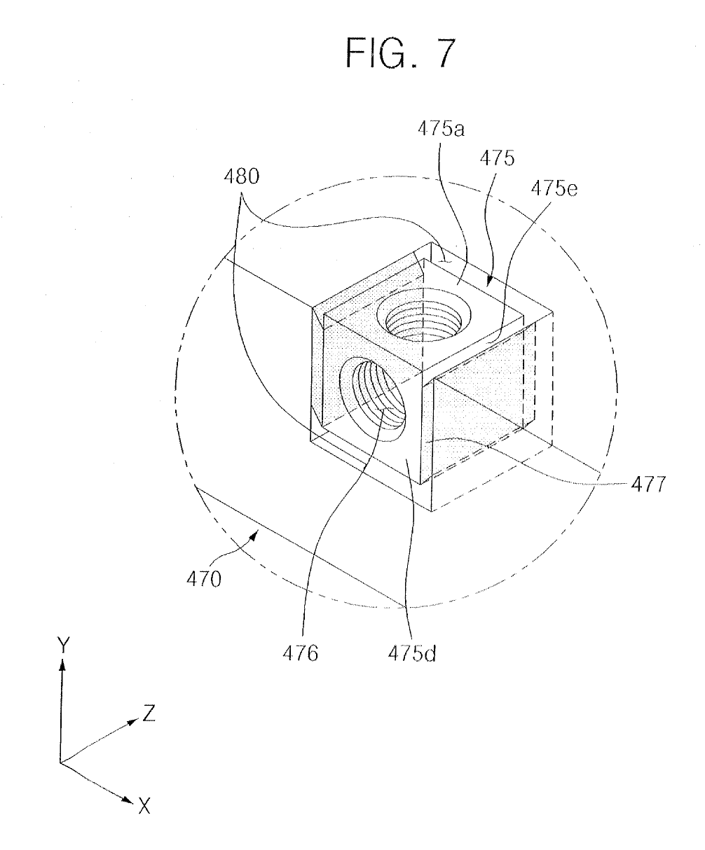

Below, a hard disk drive according to exemplary embodiments of the present general inventive concept will be described with reference to FIG. 7. Here, repetitive descriptions to the hard disk drive according to the above-described exemplary embodiments of the present general inventive concept will be avoided.

FIG. 7 is a view schematically illustrating a part of a hard disk drive according to the exemplary embodiments of the present general inventive concept. A base 470 of the hard disk drive can include a screw housing 475 and at least on screw hole 476 to receive a screw to mount the hard disk drive to an external structure. As illustrated therein, a shock-absorbing space 480 of the hard disk drive according to the exemplary embodiments of the present general inventive concept can be provided by forming a slot in a base 470 between the base 470 and two lateral walls 475e among outer walls of a screw housing 475 (e.g., except screw hole walls 475a and 475d), and the two lateral walls 475e of the screw housing 475 and the base 470 are coupled as a single body. Thus, the screw housing 475 in the exemplary embodiments illustrated in FIG. 7 can have a cantilever structure.

A coupling wall 477 can couple the two lateral walls 475e of the screw housing 475 with the base 470 and can have a cross-section inclined with respect to the top surface of the base 470 to minimize the shock and/or vibration in the up and down directions (e.g., in the Z-axis direction).

In the hard disk drive according to exemplary embodiments illustrated in FIG. 7, the screw housing 475 can be transformed by external shock and/or vibration in a direction (e.g., in a Y-axis direction) transverse to a lengthwise direction of the base 470 and in up and down directions (e.g., in a Z-axis direction) of the base 470, absorbing the shock and/or minimizing the vibration applied in one or more directions.

The exemplary embodiments of the present inventive concept illustrated in FIG. 7 can be a double cantilever structure where the two lateral walls 475e of the screw housing 475 are coupled to the base 470, but is not limited thereto. Alternatively, instead of the double cantilever structure, other two lateral walls, i.e., the top wall and one lateral wall 475e, may be coupled to the base 470.

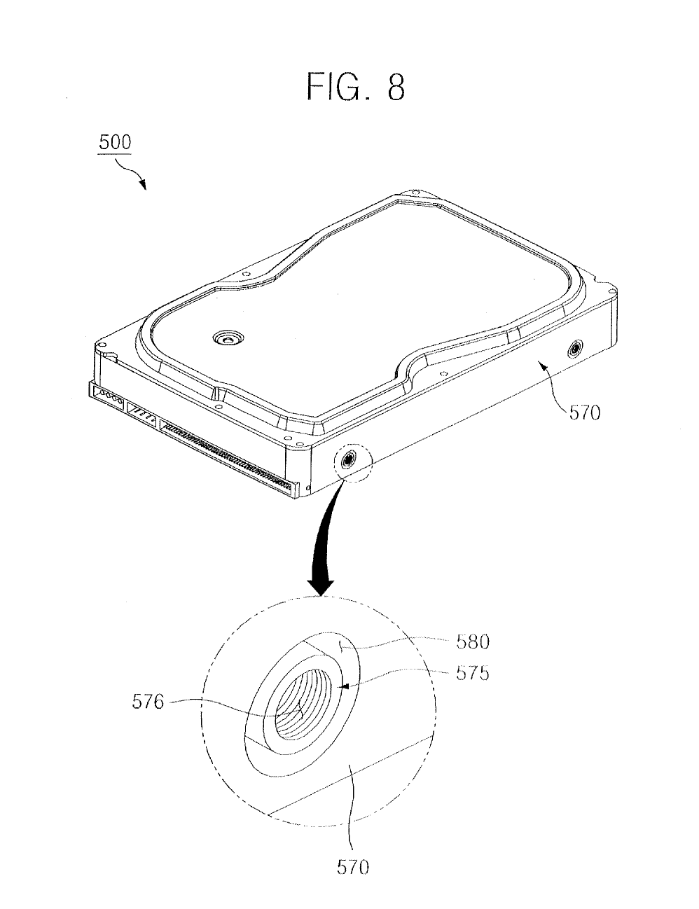

Below, a hard disk drive according to exemplary embodiments of the present inventive concept will be described with reference to FIG. 8. Here, repetitive descriptions to the hard disk drive according to the above-described exemplary embodiments of the present inventive concept will be avoided.

FIG. 8 is a view schematically illustrating a part of a hard disk drive according to exemplary embodiments of the present general inventive concept. A base 570 of the hard disk drive can include a screw housing 575 and at least on screw hole 576 to receive a screw to mount the hard disk drive to an external structure. As illustrated in FIG. 8, a screw housing 575 of the hard disk drive 500 can have a cylindrical shape with a screw hole at the center thereof, and a shock-absorbing space 580 can be provided by forming a slot in a base 570 between the cylindrical screw housing 575 and the base 570. The screw housing 575 in the exemplary embodiments illustrated in FIG. Scan have the cylindrical shape, and the screw housing 575 can be coupled to the base 570 in the form of a cantilever. The hard disk drive according to the exemplary embodiments of the present general inventive concept illustrated in FIG. 8 can absorb an external shock and/or dampen vibration in one or more directions

While the present general inventive concept has been particularly illustrated and described with reference to several exemplary embodiments thereof, it will be understood that various changes in form and details may be made therein without departing from the spirit and scope of the following claims.

What is claimed is:

1. A hard disk drive comprising:
a base;
a screw housing having at least one screw hole wall formed with a screw hole, and provided at lateral sides of the base; and
a shock-absorbing space formed between the base and at least a part among outer walls of the screw housing except the screw hole wall.

2. The hard disk drive according to claim 1, wherein
the screw hole wall is formed in two outer walls of the screw housing at positions exposed to an outside of the base, and
the shock-absorbing space is formed between the base and three outer walls among four outer walls of the screw housing.

3. The hard disk drive according to claim 2, wherein the shock-absorbing space includes at least a first space and a second space formed between the base and three outer walls among four outer walls of the screw housing that is coupled to the base in the form of a cantilever so that the first space and the second space of the shock-absorbing space continuously communicate with one another.

4. The hard disk drive according to claim 3, wherein the screw housing comprises:
a cantilever structure where a rear wall of the screw housing opposite to a lengthwise central axis of the base is coupled to the base.

5. The hard disk drive according to claim 1, wherein the shock-absorbing space is formed between the base and two outer walls among four outer walls of the screw housing.

6. The hard disk drive according to claim 5, wherein the screw housing comprises:
a double cantilever structure where two lateral walls of the screw housing are disposed transversely to a lengthwise central axis of the base and are coupled to the base.

7. The hard disk drive according to claim 6, further comprising:
a coupling wall to couple the two lateral walls of the screw housing with the base, and includes a cross-section inclined with respect to a top surface of the base.

8. The hard disk drive according to claim 1, wherein
the base and the screw housing are a single body, and
the shock-absorbing space is provided by a slot formed in at least one of the base and the screw housing.

9. The hard disk drive according to claim 8, wherein
the shock-absorbing space is provided by a slot formed in the base, and
the shock-absorbing space is filled with a damper material to absorb at least a part of a shock.

10. The hard disk drive according to claim 1, wherein the base and the screw housing are coupled to each other to form the shock-absorbing space.

11. The hard disk drive according to claim 10, wherein the base and the screw housing are formed of different materials from each other.

12. A digital storage device mounting apparatus, comprising:
a base to mount a digital storage device; and
a screw housing having a plurality of sides and at least one screw hole wall, the screw housing mounted on a side of the base such that at least one of the plurality of sides of the screw housing are spaced from the side of the base.

13. The apparatus of claim 12, wherein the screw housing comprises:
a double cantilever structure having two lateral walls that are disposed transversely to a lengthwise central axis of the base and are coupled to the base.

14. The apparatus of claim 13, further comprising:
a coupling wall to couple the two lateral walls of the screw housing with the base and that includes an inclined cross-section.

15. The apparatus of claim 12, further comprising:
a damping material disposed between the base and the side of the screw housing.

16. The apparatus of claim 12, wherein the base and the screw housing are formed of different materials from one another.

17. A hard disk drive assembly, comprising:
a base to support a digital storage device; and
a screw housing extending from the base and separated from side walls of the base to provide a shock-absorbing space with respect to the walls of the base, the screw housing including a screw hole extending therethrough.

18. The hard disk drive assembly of claim 17, wherein the shock-absorbing space is formed between the walls of the base and outer walls of the screw housing.

19. The hard disk assembly of claim 17, wherein the screw housing comprises:
a cantilever structure where a rear wall of the screw housing opposite to a lengthwise central axis of the base is coupled to the base.

20. The hard disk assembly of claim 17, wherein the shock-absorbing space includes at least a first space and a second space formed between the base and the screw housing that is coupled to the base in the form of a cantilever so that the first space and the second space of the shock-absorbing space continuously communicate with one another.
